(19) United States
(12) Patent Application Publication
(10) Pub. No.: US 2009/0220719 A1
(43) Pub. Date: Sep. 3, 2009

(54) LOW FUEL-PERMEABLE THERMOPLASTIC VESSELS BASED ON POLYOXYMETHYLENE

(76) Inventors: Jeremy Klug, Union, KY (US); Joseph George Tajar, Hillsborough, NJ (US)

Correspondence Address: DORITY & MANNING, P.A., POST OFFICE BOX 1449, GREENVILLE, SC, 29602-1449, US

(21) Appl. No.: 12/066,572

(22) PCT Filed: Sep. 14, 2006
(86) PCT No.: PCT/US06/35687

§ 371 Date: Jul. 29, 2008

Related U.S. Application Data
(60) Provisional application No. 60/718,053, filed on Sep. 16, 2005.

(51) Int. Cl. B32B 1/00; B29C 39/00; B29C 49/00; C08L 75/04

(52) U.S. Cl. 428/36.92; 264/311; 264/531; 525/185

(57) ABSTRACT

The present invention relates to thermoplastic hollow vessels, tanks, drums and other industrially applicable housings. The invention is adaptable as plastic fuel tanks with low fuel permeability, e.g., less than 5 g.·mm/m2 day as a mono-layer structure. These vessels exhibit good sub 0 0C impact properties and are formed by relatively inexpensive blow molding or rotomolding processes. Disclosed are mono-layered hollow vessels comprising an uncompatibilized, fused blend composition of polyoxymethylene, thermoplastic polyurethane and a copolyester. In one embodiment mono-layered hollow vessels comprise uncompatibilized, fused polyoxymethylene, thermoplastic polyurethane and copolyester in the respective wt. amounts of 100, 5-15 and 5-15. According to a more preferred aspect the wt. ratio of thermoplastic polyurethane to copolyester is from 1:3 to 3:1.

### CLAIM FOR PRIORITY

This patent application claims the benefit of the filing date of U.S. Provisional Patent Application Ser. No. 60/718,053, of the same title, filed Sep. 15, 2005, the disclosure of which is incorporated herein by reference in its entirety.

### TECHNICAL FIELD

The present invention relates to thermoplastic hollow vessels, tanks, drums and other industrially applicable housings. The invention is especially adaptable to plastic fuel tanks.

### BACKGROUND

The fabrication of suitable vessels out of polyoxymethylene requires improvement of its impact properties. A number of approaches to toughen polyoxymethylene are reported.

U.S. Pat. No. 5,693,709 discloses a combination of polyoxymethylene, 0.01 to 5 parts per hundred wt. (PPH) polyoxymethylene of an alkali metal salt of a polybasic acid, 0.01 to 5 PPH of a polyalkylene glycol, e.g., PEG, and/or 0.1 to 100 PPH of a thermoplastic polyurethane.

U.S. Pat. Pub. No. 2005/017433 discloses blow-molded multi-layered fuel containers comprising an inner barrier layer of polyacetal resin in intimate unbonded surface-to-surface contact with an outer polyolefin layer.

U.S. Pat. No. 5,286,807 discloses an impact resistant polyoxymethylene composition consisting essentially of 5 to 15 wt % of a thermoplastic polyurethane having a soft segment glass transition temperature of lower than 0° C., and 85 to 95 wt % of a polyoxymethylene polymer having a number average molecular weight of 20,000 to 100,000, the thermoplastic polyurethane being dispersed in the polyoxymethylene as discrete particles.

U.S. Pat. No. 4,804,716 discloses a polyoxymethylene composition consisting essentially of 60 to 85 wt. % of a polyoxymethylene polymer and 15 to 40 wt % of a thermoplastic polyurethane dispersed phase.

U.S. Pat. No. 5,244,946 discloses thermoplastic polymer blends comprising a monovinylidene aromatic copolymer optionally modified with a rubber, a polyoxymethylene polymer and an elastomeric material selected from a thermoplastic polyurethane or an elastomeric copolyester.

It is known that polyoxymethylene compositions containing thermoplastic polyurethane suffer from various deficiencies including the handling difficulties in an injection molding process due to their low thermal stability, and in an extrusion process due to their phase separation or die swelling. Compatibilizing agents have been reported to overcome these deficiencies. For example, U.S. Pat. No. 6,512,047 is directed to injection-molded compositions characterized by reduced die swell by improving the homogeneity using a compatibilizer. The compositions comprise blends of polyoxymethylene, thermoplastic polyester, thermoplastic polyurethane and maleinized polyolefin compatibilizer.

Reduced fuel permeability can be achieved by the use of multilayer containers prepared by co-processing individual polymers in injection or extrusion operations or by laminating individually formed layers together or by a combination of these processes. Exemplary multi-layered thermoplastic shapes reported include U.S. Pat. Pub. No. 2005/017433 directed to blow-molded multi-layered fuel containers comprising an inner barrier layer of polyoxymethylene in intimate unbonded surface-to-surface contact with an outer polyolefin layer. U.S. Pat. No. 5,891,373 to Hunter discloses a multi-layer hydrocarbon vapor-impermeable tube formed by coextruding nylon as outer layer and a vapor barrier inner layer such as ETFE, bonded by two adhesive layers.

With respect to fuel tanks made from polyolefin thermoplastics, HDPE for instance exhibits a fuel permeability of greater than 50 g.·mm/m² day which will exceed upper limits recently proposed by state and federal regulatory agencies. Exemplary known approaches for reducing fuel permeability of HDPE include the use of nylon/HPDE blends, post-fluorination of HPDE, and post-sulfonation of HDPE shapes, but these approaches add complexity and cost.

Despite numerous teachings relating to thermoplastics which may be toughened, stabilized, and/or composited into multi-layered shapes, no teachings are seen from the standpoint of minimizing fuel permeability with mono-layer fuel vessels derived from a single major component thermoplastic absent some post-treatment, e.g. coating. An unmet need exists for suitable mono-layer thermoplastic vessels having low fuel permeability, e.g., less than 5 g. mm/m² day and good low temperature impact properties which can be formed via relatively inexpensive blow molding or rotomolding processes.

### SUMMARY OF THE INVENTION

The invention is directed to powder compositions and mono-layered hollow vessels derived therefrom and exhibiting a Fuel “C” plus methyl t-butyl ether (MTBE) permeability of less than 5 g.·mm/m² day. The compositions and vessels derived therefrom comprise an uncompatibilized blend composition of polyoxymethylene, thermoplastic polyurethane and a copolyester. The preferred compositions and hollow vessels therefrom comprise polyoxymethylene, thermoplastic polyurethane and copolyester in the respective wt. amounts of 100, 5-15 and 5-15 and exhibit a Fuel “C” plus 11% MTBE permeability of less than 2 g.·mm/m² day. According to a more preferred aspect as to compositions and vessels therefrom, the wt. ratio of thermoplastic polyurethane to copolyester is from 1:3 to 3:1, and more preferably is from 1:2-2:1.

Another aspect of the invention is a process for making a hollow container by rotomolding an uncompatibilized, but fused blend of polyoxymethylene, thermoplastic polyurethane and copolyester until the composition is sintered, allowing the composition to cool and removing the resulting shaped vessel from the mold.

In a preferred aspect, the process for rotomolding entails positioning an amount of a powdered, uncompatibilized fused thermoplastic composition comprising polyoxymethylene, thermoplastic polyurethane and copolyester in respective weight parts of 100, 5-15 and 5-15 into a rotational mold, heating the mold and biaxially rotating the mold until the composition is sintered, cooling the mold and removing the hollow shaped vessel formed thereby. In the preferred aspect of the rotomolding method, the wt. ratio of thermoplastic polyurethane to copolyester is from 1:3 to 3:1, and preferably is from 1:2-2:1.

Another aspect of the invention is a process for making a hollow container by blowmolding comprising extruding an uncompatibilized but fused blend composition of polyoxymethylene (1), thermoplastic polyurethane (2) and copolyester (3). The preferred aspect in the method of blow molding is the use of such blend composition in which the respective wt. amounts of (1), (2) and (3) are 100, 5-15 and 5-15 by extrusion to form of a hollow parison, clamping the parison, injecting gas within the parison thereby pressing the wall of the parison against the inner surface of a mold, allowing the shaped form to cool and ejecting the shaped part from the opened mold. In a further preferred aspect, the method for blowmolding entails extrusion of an uncompatibilized composition comprising polyoxymethylene, thermoplastic polyurethane and copolyester in respective weight parts of 100, 5-15 and 5-15, wherein the wt. ratio of thermoplastic polyurethane and copolyester is from 1:3 to 3:1, preferably 1:2-2:1.

The vessels according to the invention are surprisingly capable of achieving an equilibrium fuel permeation rate of less than 5 grams of Fuel “C” plus 11% MTBE per mm (wall) thickness of vessel per m² area of sample per day (per MOCON) while exhibiting excellent room temperature and 40° C. drop weight impact, whereas the individual polyurethane and copolyester components employed exhibit Fuel “C” plus 11% MTBE permeability of more than 200 g.·mm/m² day. Therefore, industrially important thermo-processable, tough, fuel barrier materials have been found that are suitable for mono-layer fuel vessels which avoid added cost and complexity of the multi-layered or post-treated monolayer approaches.

### DETAILED DESCRIPTION OF THE INVENTION

The invention is described in such detail to direct persons having ordinary skill in the thermoplastic field in making and using the invention and is for purposes of exemplification only and is not intended to be limitative of the invention as defined in the appended claims. Terminology is given its ordinary meaning as supplemented in this description.

The term “uncompatibilized” in the context of thermoplastic compositions used in the present invention, means that the compositions do not contain compatibilizers, as these agents are generally known in the art.

Rotational molding is commonly practiced on a large commercial scale and need not be disclosed in great detail. Additional information on rotational molding can be obtained from publications of the Association of Rotational Molders Association, 2000 Spring Road, Suite 511 Oak Brook, Ill. 60523 or www.rotomolders.com. In a preferred practice of the present invention for forming hollow vessels, a polyoxymethylene composition disclosed herein which has been ground to a fine powder is portioned to a predetermined quantity depending on the surface geometry as defined by the mold and desired wall thickness for the vessel, and this quantity is placed inside a rotational mold, e.g., an aluminum mold. The mold is heated and rotated at predetermined speed usually in a biaxial rotational pattern. The thermoplastic composition fuses and forms a coating conforming to the inside of the mold. The mold is then cooled wherein the shaped form solidifies, with the outer hollow vessel surface taking the shape and general surface characteristics of the inside surface of the mold.

In the practice of a blow molding embodiment the polyoxymethylene composition in conventional pellet form is formed into vessels by expanding an extruded hot parison of the composition against the internal surfaces of a mold with gas. In a conventional continuous process, a stationary extruder is employed to push the molten polyoxymethylene composition through the die to form a continuous parison. For larger vessel blow molding, accumulators may used to prevent sagging of the polyoxymethylene parison.

A preferred embodiment of the present invention is directed to a mono-layer fuel container having a fluid capacity of 20 liters or less, preferably 10 liters and less, more preferably 3 liters or less, and most preferably 1 liter or less.

The vessels according to the invention are composed of a major (>50 wt. %) weight proportion of polyoxymethylene. This resin is characterized by major proportion of the total repeating units being oxymethylene repeat units. Further information on polyacetals may be found in “Acetal Resins,” by T. J Dolce and John A. Grates, Second Edition of Encyclopedia of Polymer Science and Engineering, John Wiley and Sons, New York, 1985, Volume 1, pp. 46-61. Homopolymer may be prepared by polymerizing anhydrous formaldehyde or the trimer, trioxane. Polyoxymethylenes of suitable MW for use herein may be prepared by polymerizing trioxane in the presence of Lewis acid catalysts, e.g., antimony fluoride, or boron trifluoride (U.S. Pat. No. 2,989,506).

As is well known, ex reactor polyoxymethylene is stabilized predominantly by either end capping, e.g., acetylation of terminal hemiacetal (U.S. Pat. No. 2,998,409) via ester or ether groups or by hydrolysis (Celanese, see U.S. Pat. No. 3,219,623).

Preferred herein are polyoxymethylene copolymers with a proportion of 60-99.9% of recurring units being oxymethylene interspersed with the balance of oxy(higher allylene) groups. Oxy(higher allylene) groups are introduced via cyclic ether or cyclic formal having at least two adjacent carbon atoms in the ring in addition to trioxane, e.g., via ethylene oxide 1,3-dioxolane with trioxane. The preferred polyoxymethylene resins used herein have a number average molecular weight of at least 10,000 and I.V. of least 1.0 (at 25° C. in a 0.2 wt. % solution in HFIP).

Suitable crystalline polyoxymethylene copolymers are sold by Ticona LLC under the CELCON® brand have exemplary melt indices of 1.3, 2.3, 2.7 up to about 5.0 g/10 min. or more when tested in accordance with ASTM D1238-82. Utilization of polyoxymethylene having a melt flow index of above 5 is expected to yield relatively lower drop impact performance and attempts to overcome this deficiency in the use of levels of thermoplastic polyurethane and copolyester above the levels specified herein, fuel permeability will suffer significantly. Surprisingly good drop impact strength at −40° C. is obtained in the composition of polyoxymethylene, thermoplastic polyurethane and copolyester when the polyoxymethylene resin employed has a melt index of 2.2±0.5 cm.³/10 min. @190° C., 2.16 kg. load, while obtaining a Fuel “C” plus 11% MTBE permeability of less than 2 g·mm/m² day.

The hollow vessel also contains a copolyester which is a polyester copolymer having a crystalline hard segment and a non-crystalline soft segment; the hard segment is prepared by reacting and polycondensing an aromatic diacid or allyl ester of an aromatic diacid with a short-chain diol and the soft segment is formed from a long-chain diol. Exemplary aromatic diacids and alkyl esters thereof include dimethyl terephthalate, terephthalic acid, isophthalic acid, dimethyl isophthalate, 1,5-naphthalene dicarboxylic acid, 2,6-naphthalene dicarboxylic acid, dimethyl 2,6-naphthalate, and mixtures thereof. Among them, dimethyl terephthalate is preferred.

Short-chain diols used include 1,4-butanediol, 1,6-hexanediol and ethylene glycol; and representative long-chain diols may include polytetramethylene ether glycol, polyethylene glycol, and mixtures thereof, having an average molecular weight of 500 to 5,000. Preferably greater than 50% of the short-chain diol segments have a molecular weight of from 3000-8000, preferably from 4000-6000 and have a melting point of 150° C. and higher, preferably 200° C. and higher. The diols 1,4-butanediol and polytetramethylene ether glycol are preferred as a short-chain diol and a long-chain diol, respectively. Typical terminal groups of the polyester elastomer are carboxyl and hydroxyl groups.

In terms of mole percentage of copolyester hard and soft segments, the preferred copolyester polymer contains 70 to 98 mole percent of a hard segment comprising polybutylene terephthalate (PBT) and 2 to 30% of soft segment comprising polytetramethylene ether glycol. A copolymer containing 70 mole % to 85 mole % hard segment derived from PBT and 15 mole % to 30 mole % soft segment of polytetramethylene ether glycol is the more preferred copolyester. Commercially available polyesters of this type are sold by Ticona under the RITEFLEX® trademark. A preferred exemplary copolyester is RITEFLEX 640 having a Shore D hardness of 40.

The preferred copolyesters are copolymers of polybutylene terephthalate and polytetramethylene glycol, a block copolymer of polybutylene terephthalate/polybutylene isophthalate and polyethylene glycol/polypropylene glycol, a block copolymer of polybutylene terephthalate/polyhexene terephthalate and polytetramethylene glycol, and a block copolymer of polyurethane and polytetramethylene glycol.

The preferred copolyester used herein has a T_{g} less than 0° C., typically about −20° C., and a softening point of from 150-180° C., e.g., about 170° C. The thermoplastic polyester appears to form a dispersed phase with polyoxymethylene and is advantageously employed in an amount ranging from 5 to 15 PPH, more preferably 7 to 12 PPH. The preferred copolyesters are commercially available from du Pont De Nemours, Inc. under the Hytrel® brand and from Ticona under the Riteflex® brand.

The thermoplastic polyurethane elastomer employed herein has a soft segment of long-chain diol having an average molecular weight of 800 to 2,500 and a hard segment derived from a diisocyanate and a chain extender, and will generally have a T_{g} of −40° C. to 20° C. and a softening point of from 70-100° C. The preferred polyurethane elastomer is a polyester type prepared by reacting a long-chain diol with a diisocyanate to produce a polyurethane prepolymer having isocyanate end groups, followed by chain extension of the prepolymer with a diol chain extender. Representative long-chain diols are polyester diols such as poly(butylene adipate)diol, poly(ethylene adipate)diol and poly(ε-caprolactone)diol; and polyether diols such as poly(tetramethylene ether)glycol, poly(propylene oxide)glycol and poly(ethylene oxide)glycol. Suitable diisocyanates include 4,4′-methylenebis(phenyl isocyanate), 2,4-toluene diisocyanate, 1,6-hexamethylene diisocyanate and 4,4′-methylenebis-(cycloxylisocyanate), wherein 4,4′-methylenebis(phenyl isocyanate) and 2,4-toluene diisocyanate are preferred. Suitable chain extenders are C₂-C₆ aliphatic diols such as ethylene glycol, 1,4-butanediol, 1,6-hexanediol and neopentyl glycol. The preferred thermoplastic polyurethane is characterized as essentially poly(adipic acid-co-butylene glycol-co-diphenylmethane diisocyanate). A good balance of properties are obtained in a trade-off between prop Weight Impact performance and fuel permeability for the composition of polyoxymethylene, thermoplastic polyurethane and copolyester when the thermoplastic polyurethane is a polyester having a Shore A hardness of from 78 to 88 (DIN 53505) and a melt flow index of 70-20 g./10 min.@210° C., 10 kg. An Example of a preferred thermoplastic polyurethane elastomer is ELASTOLLAN® commercially available from BASF Polyurethane Elastomers Co. Thermoplastic polyurethane employed herein forms a dispersed phase and is employed in an amount ranging from 5-15 PPH, preferably, 7-12 PPH.

Optional adjuvants may be employed as are convention, such as pigments, tinting agents, a variety of stabilizers, e.g., UV, thermal, acid or formaldehyde scavengers, e.g., hindered phenols, Ca stearate; lubricants, e.g., alkylene bis-stearamide, and processing aids.

The molding composition is prepared by drying the individual components in a dry air oven at a suitable temperature of 70-110° C. prior to blending in a mixer such as Brabender® to form an uncompatibilized, fused blend or fusing and melt mixing in a conventional single or twin screw extruder at a temperature above the melting point of polyoxymethylene, e.g., 180-230° C., preferably 190-210° C. forming extruded fused strands which are pelletized in the conventional manner. Prior to compounding, the thermoplastic polyurethane and copolyester are dried to a moisture content of about 0.05 wt. % or less. The melt-processed, pelletized compound is then ground to a particle size in the range of 100-500 microns. Commercial contract grinders capable of grinding the compositions of the present invention include ICO Polymers of Grand Junction, Tenn. and Brunk Corporation of Goshen, Ind. In terms of a typical sieve analysis the ground powders typically will show the following result:

| U.S. mesh size | 30 | 35 | 50 | 60 | 80 | 100 | Pan |
|---|---|---|---|---|---|---|---|
| % retained | 0 | 1 | 40 | 20 | 20 | 10 | 9 |

### EXAMPLES

The following compositions were blended and compounded using a conventional twin-screw extruder (ZSK, Coperion) pelletized and formed into test plaques for comparison of drop impact and fuel permeability. Drop weight impact data below represent an average of 5 runs using 0.125 in.×4 in. disc-shaped, injection molded specimens.

| | | | | | | Drop Weight Impact | | | |
|---|---|---|---|---|---|---|---|---|---|
| | Components¹ | | | | | (lb_{f} · ft)² | | | Permeation³ |
| Example | A | B | C | D | E | −40° C. | −23° C. | 23° C. | (g · mm/m² day) |
| 1 | 80 | | | 10 | 10 | 14.2 | 13.3 | 37.1 | |
| 2 | | 80 | | 10 | 10 | 35.1 | 33.5 | 39.9 | 1.4 |
| 3 | | | 80 | 10 | 10 | 16.3 | 35.9 | 40.8 | |
| 4 | 100 | | | | | 4.5 | 6.2 | 11.0 | 0.06 |
| 5 | | | | 100 | | | | | 270 |
| 6 | | | | | 100 | | | | 700 |
| 7 | 80 | | | 20 | | 12.6 | 37.9 | 40.1 | 2.7 |
| 8 | 90 | | | 10 | | | 7.0 | 18.2 | 1.2 |

¹A - polyoxymethylene copolymer with melt flow 1.3 cm.³/10 min. @190° C., 2.16 kg.
B - polyoxymethylene copolymer with melt flow 2.2 cm.³/10 min. @190° C., 2.16 kg.
C - polyoxymethylene copolymer with melt flow 2.7 cm.³/10 min. @190° C., 2.16 kg.
D - thermoplastic polyurethane with melt flow index 80-120 g./10 min. @ 210° C., 10 kg
E - copolyester elastomer: Riteflex 640, melt flow 8-12 gms. @ 220° C., 2.16 kg.
²Drop Impact is per ASTM D 3763 at an impact velocity of 11 ft. per sec.
³Equilibrium permeation in Fuel “C” (toluene:isooctane 1:1) with 11% MTBE at 40° C. The reported units of g · mm/m² day is grams of fuel per mm (wall) thickness of sample per m² area of sample per day.

Equilibrium permeation of Fuel C with MTBE was tested over a period of several weeks by speciated fuel permeation technique from MOCON, 7500 Boone Avenue North, Minneapolis, Minn. 55428. In this test a molded section of the test piece is secured in a nitrogen-purged aluminum cell equipped with a temperature controlled water bath with the fuel mixture on one side and a helium carrier gas flowing on the other. Permeation of the fuel vapor through the test sample is picked up by the carrier gas, and separated in a capillary chromatographic column equipped with a flame ionization detector. The temperature of the sample material and fuel is maintained to the set temperature of 40° C. within 0.25° C.

While the invention has been described in detail in connection with numerous potential embodiments, modifications to those embodiments within the spirit and scope of the present invention, set forth in the appended claims, will be readily apparent to those of skill in the art.

What is claimed is:

1. A mono-layered hollow vessel comprising an uncompatibilized, fused blend composition comprising polyoxymethylene, thermoplastic polyurethane and a copolyester.

2. The vessel according to claim 1 exhibiting a permeability of less than 5 g.·mm/m² day in Fuel “C” plus 11% MTBE at 40° C. wherein said polyoxymethylene, thermoplastic polyurethane and copolyester are present in weight amounts of 100, 5-15 and 5-15.

3. The vessel according to claim 1 wherein the weight ratio of thermoplastic polyurethane to copolyester is from 1:3 to 3:1.

4. The vessel according to claim 3 wherein said weight ratio is from 1:2-2:1 and permeability is less than 2 g. mm/m² day in Fuel “C” plus 11% MTBE at 40° C.

5. The vessel according to claim 1 having a fluid capacity of 20 liters or less.

6. The vessel according to claim 1 wherein said polyoxymethylene has a melt index of 2.2±0.5 cm.³/10 min.@190° C., 2.16 kg load.

7. The vessel according to claim 6 wherein said thermoplastic polyurethane a has Shore A hardness of from 78 to 88 (DIN 53505) and a melt flow index of 70-120 g./10 min.

8. The vessel according to claim 1 wherein said copolyester comprises 70-98 mol % of a hard segment comprising polybutylene terephthalate and 2% to 30% of soft segment comprising polytetramethylene ether glycol.

9. A process for forming a hollow vessel container comprising portioning a predetermined amount of a powder composition into a rotational mold, said powder composition comprising an uncompatibilized blend of polyoxymethylene, thermoplastic polyurethane and copolyester, heating said mold and biaxially rotating said mold until said composition is sintered, allowing the composition to cool and removing the resulting shaped vessel from the mold.

10. The process according to claim 9 wherein said polyoxymethylene, thermoplastic polyurethane and copolyester are contained in respective weight parts of 100, 5-15 and 5-15.

11. The process according to claim 10 the weight ratio of thermoplastic polyurethane to copolyester is from 1:3 to 3:1.

12. The process according to claim 11 wherein said weight ratio is from 1:2-2:1.

13. A process for forming a blow molded vessel comprising extruding an uncompatibilized but fused blend composition of polyoxymethylene, thermoplastic polyurethane and copolyester to form of a hollow molten parison, clamping the parison, injecting gas within the parison thereby pressing the wall of the parison against the inner surface of a mold, allowing the shaped form to cool and ejecting the shaped part

14. The process according to claim 13 wherein polyoxymethylene, thermoplastic polyurethane and copolyester are contained in said composition in respective weight parts of 100, 5-15 and 5-15.

15. The process according to claim 14 wherein the weight ratio of thermoplastic polyurethane and copolyester is from 1:3 to 3:1.

16. The process according to claim 15 wherein said weight ratio is 1:2-2:1.

17. A composition in powder form having particles in the range of 100-500 microns ground from a fused, incompatibilized composition comprising polyoxymethylene, thermoplastic polyurethane and copolyester are contained in said composition in respective weight parts of 100, 5-15 and 5-15.

18. The composition according to claim 17 wherein the weight ratio of thermoplastic polyurethane to copolyester is from 1:3 to 3:1.

19. The composition according to claim 17 wherein said polyoxymethylene has a melt index of 2.2±0.5 cm.³/10 min. @190° C., 2.16 kg load.

20. The composition according to claim 19 wherein said thermoplastic polyurethane a has Shore A hardness of from 78 to 88 (DIN 53505) and a melt flow index of 70-120 g./10 min.
